(19) United States
(12) Patent Application Publication
(10) Pub. No.: US 2026/0204804 A1
(43) Pub. Date: Jul. 16, 2026

(54) ANTENNA ARRANGEMENT FOR A RADAR SYSTEM, RADAR SYSTEM, DRIVER ASSISTANCE SYSTEM, VEHICLE AND METHOD FOR OPERATING A RADAR SYSTEM

(71) Applicant: VALEO SCHALTER UND SENSOREN GMBH, Bietigheim-Bissingen (DE)

(72) Inventors: Christian Sturm, Bietigheim-Bissingen (DE); Leen Sit, Bietigheim-Bissingen (DE); Hamid Afrasiabi Vayghan, Bietigheim-Bissingen (DE); Miquel Testar Quer, Bietigheim-Bissingen (DE); Kevin Krupinski, Bietigheim-Bissingen (DE)

(73) Assignee: VALEO SCHALTER UND SENSOREN GMBH, Bietigheim-Bissingen (DE)

(21) Appl. No.: 19/134,055

(22) PCT Filed: Nov. 27, 2023
(86) PCT No.: PCT/EP2023/083096

§ 371 Date: May 29, 2025

(30) Foreign Application Priority Data
Nov. 29, 2022 (DE) 10 2022 131 456.1

(51) Int. Cl. H01Q 21/06; H01Q 1/32

(52) U.S. Cl. CPC H01Q 21/061; H01Q 1/3233; H01Q 1/3283

(57) ABSTRACT

Described is an antenna assembly for a radar system for a vehicle having four type-1 antenna elements of a first antenna element type (transmission elements), and at least two type-2 antenna elements of a second antenna element type (receiving elements). The type-1 antenna elements are arranged on a plane on the corners of an imaginary flat rectangle, where two of the sides of the rectangle extend parallel to an imaginary first assembly axis and form type-1 antenna element main axes. The two other sides of the rectangle extend parallel to an imaginary second assembly axis, perpendicular to the first assembly axis, and form type-1 antenna element transverse axes. Two of the type-2 antenna elements are arranged on different imaginary type-2 antenna element main axes which extend parallel to each other in a mutually spaced manner and parallel to one of the assembly axes.

### TECHNICAL FIELD

The invention relates to an antenna arrangement for a radar system, in particular for a radar system for a vehicle, which has four type-1 antenna elements of a first antenna element type and at least two type-2 antenna elements of a second antenna element type, one of the antenna element types being transmitting antenna elements and the other of the antenna element types being receiving antenna elements.

The invention further relates to a radar system with at least one antenna arrangement which has four type-1 antenna elements of a first antenna element type and at least two type-2 antenna elements of a second antenna element type, one of the antenna element types being transmitting antenna elements and the other of the antenna element types being receiving antenna elements.

The invention also relates to a driver assistance system with at least one radar system and with at least one antenna arrangement for the at least one radar system, the at least one antenna arrangement having four type-1 antenna elements of a first antenna element type and at least two type-2 antenna elements of a second antenna element type, one of the antenna element types being transmitting antenna elements and the other of the antenna element types being receiving antenna elements.

In addition, the invention relates to a vehicle with at least one radar system and with at least one antenna arrangement for the at least one radar system, the at least one antenna arrangement having four type-1 antenna elements of a first antenna element type and at least two type-2 antenna elements of a second antenna element type, one of the antenna element types being transmitting antenna elements and the other of the antenna element types being receiving antenna elements.

Finally, the invention relates to a method for operating a radar system, in particular a radar system for a vehicle, with at least one antenna arrangement which has four type-1 antenna elements of a first antenna element type and at least two type-2 antenna elements of a second antenna element type, wherein in the method radar signals are sent with the antenna elements of one of the antenna element types and echo signals which originate from the radar signals sent are received with the antenna elements of the other antenna element type.

### Prior Art

A radar device with an arrangement of transmitting and receiving antennas is known from US 2021/0184367 A1. The number of transmitting antennas is 4 and the number of receiving antennas is 4. The transmitting antennas Tx #1 and Tx #2 form a first antenna group of transmitting antennas, which are identical in vertical position and different in horizontal position. The transmitting antennas Tx #3 and Tx #4 form a second antenna group, which is arranged in a position different from both the horizontal position and the vertical position in which the first antenna group is located. The receiving antennas Rx #1 to Rx #3 form a third antenna group of receiving antennas, which are identical in the vertical position and different in the horizontal position. The receiving antenna Rx #4 is a fourth antenna, which is arranged in a position different from both the horizontal position and the vertical position in which the third antenna group is arranged. In addition, the vertical position of the fourth antenna (Rx #4) is a position that is at a distance from the vertical position of the third antenna group (Rx #1 to Rx #3).

The invention is based on the object of designing an antenna arrangement, a radar system, a driver assistance system, a vehicle and a method of the type mentioned at the beginning for which it is possible in direction measurements with the radar system to increase the resolution of the direction in two dimensions, in particular in azimuth and elevation.

### Disclosure of the Invention

The object is achieved according to the invention for the antenna arrangement by providing that the type-1 antenna elements are arranged in a plane at the corners of an imaginary planar rectangle, wherein two of the sides of the rectangle extend parallel to an imaginary first arrangement axis and form type-1 antenna element main axes and the other two sides of the rectangle extend parallel to an imaginary second arrangement axis that runs perpendicularly to the first arrangement axis and form type-1 antenna element transverse axes, and at least two of the type-2 antenna elements are arranged on different imaginary type-2 antenna element main axes, which extend parallel to and at a distance from one another and parallel to one of the arrangement axes.

The antenna arrangement is intended for a radar system. The antenna arrangement allows radar signals to be sent and received. The radar signals received can be converted into corresponding receive signals, in particular electrical receive signals, which can be further processed with appropriate means, in particular a control and evaluation device.

According to the invention, the four type-1 antenna elements of the first antenna element type are arranged at the four corners of a rectangle. The sides of the rectangle extend parallel to two mutually perpendicular arrangement axes. The at least two type-2 antenna elements are arranged on type-2 antenna element main axes, which extend parallel to one of the arrangement axes.

Due to the rectangular arrangement of the type-1 antenna elements, a virtual antenna array with an enlarged aperture in two dimensions, in particular in azimuth and elevation, compared to the antenna arrangement can be realized when operating the radar system according to a MIMO method. Thus, higher resolutions can be achieved for directional measurements in both dimensions. Thus, overall the accuracy can be improved when determining directions in which detected objects are located.

The directional resolution, in particular the angular resolution, of the radar system directly depends on the size of the aperture of the virtual antenna array. Thus, overall a larger aperture can be realized in both dimensions, in particular in azimuth and elevation, with a relatively small number of antenna elements.

A rectangle in the sense of the invention may have both equal and different side lengths. Accordingly, the rectangle may also be square.

“Parallel” in the sense of the invention means that the corresponding axes may also coincide, that is to say the axes may be parallel or truly parallel.

The designations “first” and “second” for the antenna element types are only used for easier differentiation and do not mean that one of the antenna element types is prioritized. Correspondingly, the prefixes “type-1” and “type-2” are only used to make it easier to distinguish between the two types of antenna elements. Type-1 antenna elements may be transmitting antenna elements and type-2 antenna elements may be receiving antenna elements, or vice versa.

The designations “main axes” and “transverse axes” are also only used to make it easier to distinguish between them and do not mean that one of the axes, in particular the main axis, is prioritized over the other axis, in particular the transverse axis. Correspondingly, here too, the prefixes “type-1” and “type-2” are only used to make it easier to assign the axes to the corresponding antenna element types.

The radar system may be used for vehicles, in particular motor vehicles. The radar system may be advantageously used for land vehicles, in particular passenger cars, trucks, buses, motorcycles, or the like, aircraft, in particular drones, and/or watercraft. The radar system may also be used for vehicles which can be operated autonomously or at least partially autonomously.

The radar system may be advantageously connected to at least one electronic control device of a vehicle or of a machine, in particular a driver assistance system, or be part of such a control device. In this way, at least some of the functions of the vehicle can be performed autonomously or partially autonomously.

The radar system may be used for detecting stationary or moving objects, in particular vehicles, people, animals, plants, obstacles, uneven driving surfaces, in particular pot-holes or stones, roadway boundaries, road signs, free spaces, in particular parking spaces, precipitation or the like, and/or movements and/or gestures.

In an advantageous embodiment, at least two of the type-2 antenna elements may be arranged on different imaginary type-2 antenna element transverse axes, which extend parallel to and at a distance from one another and perpendicularly to the type-2 antenna element main axes. In this way, the type-2 antenna elements can respectively be at a distance in two dimensions, to be specific in the direction of the type-2 antenna element main axes and in the direction of the type-2 antenna element transverse axes. It is thereby possible to realize sparse arrays, as they are known, in the virtual antenna array. So there are gaps in the virtual antenna array. This allows a much larger virtual antenna array, which has a much larger aperture in two dimensions, in particular in azimuth and elevation, to be realized.

In a further advantageous embodiment,
the antenna arrangement may have at least three type-2 antenna element transverse axes at a distance from one another and at least three type-2 antenna elements, wherein all distances between the respectively adjacent type-2 antenna element transverse axes are different and at least three of the type-2 antenna elements are arranged on different type-2 antenna element transverse axes,
and/or
the antenna arrangement may have at least three type-2 antenna elements, one of the type-2 antenna elements of which is arranged on one of the type-2 antenna element main axes and all the other of the type-2 antenna elements of which are arranged on the other type-2 antenna element main axis; in particular, it may be that the type-2 antenna element transverse axis containing the type-2 antenna element which is arranged on its own on the type-2 antenna element main axis does not lie between two other type-2 antenna element transverse axes,
and/or
the antenna arrangement may have at least four type-2 antenna elements, one type-2 antenna element of which is arranged on one of the type-2 antenna element main axes and all the other type-2 antenna elements of which are arranged on the other type-2 antenna element main axis, and a distance of a type-2 antenna element transverse axis on which there is the type-2 antenna element which is arranged on its own on the corresponding type-2 antenna element main axis from at least one adjacent type-2 antenna element transverse axis may be smaller than the other distances between respectively adjacent type-2 antenna element transverse axes,
and/or
the antenna arrangement may have exactly four type-2 antenna elements. In this way, overall the aperture of the virtual antenna array can be increased in the direction of the type-2 antenna element main axes.

The distances between respectively adjacent type-2 antenna element transverse axes may advantageously be different. In this way, better distribution of the virtual antenna elements in the virtual antenna array can be achieved.

Advantageously, as an alternative or in addition, one of the type-2 antenna elements may be arranged on one of the type-2 antenna element main axes and all of the other type-2 antenna elements may be arranged on the other type-2 antenna element main axis. In this way, in combination with the rectangular arrangement of the type-1 antenna elements, a larger expanse of the virtual antenna array can be achieved.

Advantageously, as an alternative or in addition, a type-2 antenna element transverse axis containing the type-2 antenna element which is arranged on its owe on the type-2 antenna element main axis may not lie between two other type-2 antenna element transverse axes. This makes it possible to realize an L-shaped arrangement of the type-2 antenna elements overall.

Advantageously, as an alternative or in addition, a distance of a type-2 antenna element transverse axis on which there is the type-2 antenna element which is arranged on its own on the type-2 antenna element main axis from at least one adjacent type-2 antenna element transverse axis may be smaller than the other distances between respectively adjacent type-2 antenna element transverse axes. It is thereby possible to keep a gap that arises due to the offset of the individual antenna element with respect to the other antenna elements smaller. Thus, overall a more even distribution of the virtual antenna elements can be achieved.

Advantageously, as an alternative or in addition, the antenna arrangement may have exactly four type-2 antenna elements. In this way, exactly four antenna elements can be respectively realized from both antenna element types. Thus, a correspondingly great number of virtual antenna elements can be realized in the virtual antenna array.

In a further advantageous embodiment,
the type-2 antenna element axes, in particular the type-2 antenna element main axes and
the type-2 antenna element transverse axes, may extend in a common imaginary plane
and/or
the type-2 antenna element axes, in particular the type-2 antenna element main axes and
the type-2 antenna element transverse axes, may extend parallel to a plane spanned by
the type-1 antenna element main axes and the type-1 antenna element transverse axes,
and/or
the type-1 antenna elements and the type-2 antenna elements may be arranged on a common carrier, in particular a common carrier plate. In this way, the antenna arrangement can be more easily produced, mounted and aligned.

Advantageously, all type-2 antenna element axes may run in one imaginary plane. In this way, the antenna arrangement can be more easily realized and aligned.

Advantageously, as an alternative or in addition, the type-2 antenna element axes may extend parallel to a plane spanned by the type-1 antenna element axes, in particular the type-1 antenna element main axes and the type-2 antenna element main axes. In this way, the alignment of the type-1 antenna elements and the arrangement of the type-2 antenna elements can be simplified.

Advantageously, as an alternative or in addition, the type-1 antenna elements and type-2 antenna elements may be arranged on a common carrier. In this way, the antenna arrangement can be produced even more easily.

Advantageously, the type-1 antenna elements and the type-2 antenna elements may be realized on a common carrier plate, in particular a printed circuit board. In this way, all antenna elements can be easily realized in one plane. When using a printed circuit board, in particular electrical connections to the antenna elements can be realized more easily.

In a further advantageous embodiment, the phase centers of at least some of the antenna elements, in particular the phase centers of all the antenna elements, may be arranged on the corresponding antenna element axes, in particular the antenna element main axes and/or the antenna element transverse axes. In this way, the positions of the antenna elements can be defined more precisely dependent on.

Advantageously, the phase centers of at least some of the antenna elements may lie at intersections of antenna element main axes with the antenna element transverse axes.

In a further advantageous embodiment, a respective distance between adjacent antenna element axes for the same antenna element type, in particular a respective distance between adjacent antenna element main axes and/or a respective distance between adjacent antenna element transverse axes for the same antenna element type, may be an integer multiple of a predetermined base distance, the base distance being half the wavelength of radar signals sent by the radar system. In this way, a particularly compact antenna arrangement can be realized. By specifying the base distance as half the wavelength of the radar signals, ambiguities and side lobes can be reduced. Furthermore, clearly directed radar signals can be realized on the transmitter side. In addition, distinct angle measurements can be carried out.

In a further advantageous embodiment,
an extent of a transmitting antenna element field which consists of the antenna elements of the transmitting-antenna element type in the direction of the first arrangement axis may be greater than an extent of a receiving antenna element field which consists of the antenna elements of the receiving-antenna element type in the direction of the first arrangement axis, and an extent of the transmitting antenna element field in the direction of the second arrangement axis may be greater than an extent of the receiving antenna element field in the direction of the second arrangement axis
and/or
the rectangle for the type-1 antenna elements may have different side lengths, the longer sides running parallel to the arrangement axis in relation to which the type-2 antenna element axes, in particular type-2 antenna element main axes or type-2 antenna element transverse axes, in the direction of which a type-2 antenna element field which consists of the type-2 antenna elements has the greatest extent also run.

Advantageously, the extent of the transmitting antenna element field in the direction of both arrangement axes may be greater than the corresponding extent of the receiving antenna element field. In this way, the receiving antenna element field to some extent fits into the transmitting antenna element field.

The arrangement of the type-1 antenna elements at the corners of an imaginary rectangle with different side lengths results in a larger virtual antenna array in the direction of the longer side of the rectangle when the positions of the antenna elements of the two antenna element types, to be specific the transmitting antenna elements and the receiving antenna elements, are geometrically folded.

The fact that the receiving antenna element field is smaller than the transmitting antenna element field allows ambiguities and side lobes to be minimized.

Advantageously, the antenna element field with the type-1 antenna elements and the antenna element field with the type-2 antenna elements can be respectively aligned such that their greater extent in each case runs in the direction of the same arrangement axis. In this way, the extent of the resultant virtual array in the direction of this arrangement axis can likewise be greater than in the direction of the other arrangement axis.

In a further advantageous embodiment,
the antenna arrangement may be designed for the use of the radar system according to a MIMO method
and/or
the type-1 antenna elements can be respectively activated and/or selected separately and the type-2 antenna elements can be respectively activated and/or selected separately.

Advantageously, the antenna arrangement may be designed for operating the radar system according to a MIMO method. The radar system may be realized as a so-called MIMO radar system. In a MIMO method (multiple-in/multiple-out method), all the antenna elements of the transmitting-antenna element type can send radar signals that are coded differently. In this way, the radar signals on the receiver side can be assigned correspondingly to the echo signals received with the antenna elements of the receiving-antenna element type. With a pure MIMO method, the aperture of the virtual antenna array realized from the antenna arrangement can be enlarged correspondingly.

Advantageously, the antenna elements can be respectively activated and/or selected separately. The number of antenna elements may thereby be utilized efficiently. Transmitting antenna elements can be activated separately. Receiving antenna elements can be selected separately. Thus, even with a relatively small number of antenna elements, a virtual antenna array with a correspondingly large number of virtual antenna elements can be realized.

Furthermore, the object is achieved for the radar system by providing that the radar system has at least one antenna arrangement according to the invention.

The radar system comprises at least one antenna arrangement which has four type-1 antenna elements of a first antenna element type and at least two type-2 antenna elements of a second antenna element type. One of the antenna element types are transmitting antenna elements and the other of the antenna element types are receiving antenna elements.

According to the invention, the type-1 antenna elements are arranged in a plane at the corners of an imaginary, planar rectangle. Two of the sides of the rectangle extend parallel to an imaginary first arrangement axis and form type-1 antenna element main axes. The two other sides of the rectangle extend parallel to an imaginary second arrangement axis, which runs perpendicularly to the first arrangement axis, and form type-1 antenna element transverse axes. At least two of the type-2 antenna elements are arranged on different, imaginary type-2 antenna element main axes, which extend parallel to and at a distance from one another and parallel to one of the arrangement axes.

Advantageously, the radar system may have means with which the radar system can be operated according to a MIMO method. In this way, a resolution, in particular angular resolution, can be improved when determining a direction of a detected object.

The object is also achieved according to the invention for the driver assistance system by providing that the driver assistance system has at least one antenna arrangement according to the invention.

The driver assistance system comprises at least one radar system and at least one antenna arrangement for the at least one radar system which has four type-1 antenna elements of a first antenna element type and at least two type-2 antenna elements of a second antenna element type. One of the antenna element types are transmitting antenna elements and the other of the antenna element types are receiving antenna elements.

According to the invention, the type-1 antenna elements are arranged in a plane at the corners of an imaginary, planar rectangle. Two of the sides of the rectangle extend parallel to an imaginary first arrangement axis and form type-1 antenna element main axes. The two other sides of the rectangle extend parallel to an imaginary second arrangement axis, which runs perpendicularly to the first arrangement axis, and form type-1 antenna element transverse axes. At least two of the type-2 antenna elements are arranged on different, imaginary type-2 antenna element main axes, which extend parallel to and at a distance from one another and parallel to one of the arrangement axes.

With a radar system, at least one monitoring area in the surroundings of the vehicle can be monitored for objects.

With the driver assistance system, the vehicle can be operated autonomously or partially autonomously, in particular on the basis of the information obtained with the at least one radar system, in particular on the basis of information about objects detected with the at least one radar system.

According to the invention, the driver assistance system has at least one antenna arrangement according to the invention. Advantageously, at least one radar system of the driver assistance system may have at least one antenna arrangement according to the invention. Since the at least one radar system is part of the driver assistance system, the antenna arrangement according to the invention of the at least one radar system is consequently likewise part of the driver assistance system, that is to say also an antenna arrangement according to the invention of the driver assistance system. This applies analogously in relation to antenna arrangements according to the invention of the vehicle that has at least one driver assistance system and/or at least one radar system.

In addition, the object is achieved according to the invention for the vehicle by providing that the vehicle has at least one antenna arrangement according to the invention.

The vehicle comprises at least one radar system and at least one antenna arrangement for the at least one radar system which comprises four type-1 antenna elements of a first antenna element type and at least two type-2 antenna elements of a second antenna element type. One of the antenna element types are transmitting antenna elements and the other of the antenna element types are receiving antenna elements.

With a radar system, at least one monitoring area in the surroundings of the vehicle can be monitored for objects.

According to the invention, the type-1 antenna elements are arranged in a plane at the corners of an imaginary, planar rectangle. Two of the sides of the rectangle extend parallel to an imaginary first arrangement axis and form type-1 antenna element main axes. The two other sides of the rectangle extend parallel to an imaginary second arrangement axis, which runs perpendicularly to the first arrangement axis, and form type-1 antenna element transverse axes. At least two of the type-2 antenna elements are arranged on different, imaginary type-2 antenna element main axes, which extend parallel to and at a distance from one another and parallel to one of the arrangement axes.

The vehicle may advantageously have at least one driver assistance system, in particular at least one driver assistance system according to the invention. With the driver assistance system, the vehicle can be operated autonomously or partially autonomously.

Advantageously, at least one radar system, in particular at least one radar system according to the invention, may be connected to a driver assistance system, in particular at least one driver assistance system according to the invention, or be part of such an assistance system. In this way, information obtained with the at least one radar system, in particular information about detected objects, can be used by the driver assistance system for autonomously or partially autonomously operating the vehicle.

Finally, the object is achieved according to the invention for the method by providing that the radar signals are sent with an antenna arrangement according to the invention and the echo signals are received with the antenna arrangement according to the invention.

According to the invention, with the antenna elements of one of the antenna element types, in particular the transmitting antenna elements, radar signals are sent from one plane, from the corners of an imaginary planar rectangle. Wherein two of the sides of the rectangle extend parallel to an imaginary first arrangement axis and the two other sides of the rectangle extend parallel to an imaginary second arrangement axis, which runs perpendicularly to the first arrangement axis. The echo signals are received with at least two of the antenna elements of the other antenna element type, in particular the receiving antenna elements, on different imaginary antenna element main axes, the antenna element main axes extending at a distance from one another parallel to one of the arrangement axes.

Advantageously, the radar system can be operated according to a MIMO method. In this way, the directions of objects detected by the radar system can be determined more accurately.

In other regards, the features and advantages indicated in connection with the antenna arrangement according to the invention, the radar system according to the invention, the driver assistance system according to the invention, the vehicle according to the invention and the method according to the invention, and their respective advantageous designs, apply correspondingly to one another, and vice versa. The individual features and advantages may of course be combined with one another, in which case further advantageous effects extending beyond the sum of the individual effects may result.

### BRIEF DESCRIPTION OF THE DRAWINGS

Further advantages, features and details of the invention will become apparent from the following description, in which exemplary embodiments of the invention are explained in more detail with reference to the drawing. A person skilled in the art will expediently also consider the features disclosed in combination in the drawing, the description and the claims individually and combine them to form further useful combinations. In the drawing, schematically,

FIG. 1 shows a plan view of a vehicle having a driver assistance system that has a radar system;

FIG. 2 shows the vehicle from FIG. 1 in side view;

FIG. 3 shows a front view of an antenna arrangement of the radar system of the vehicle from FIGS. 1 and 2;

FIG. 4 shows a front view of an alternative antenna arrangement of the radar system of the vehicle from FIGS. 1 and 2 and a virtual antenna array realized therefrom.

In the figures, the same components are provided with the same reference signs.

### Embodiment(s) of the Invention

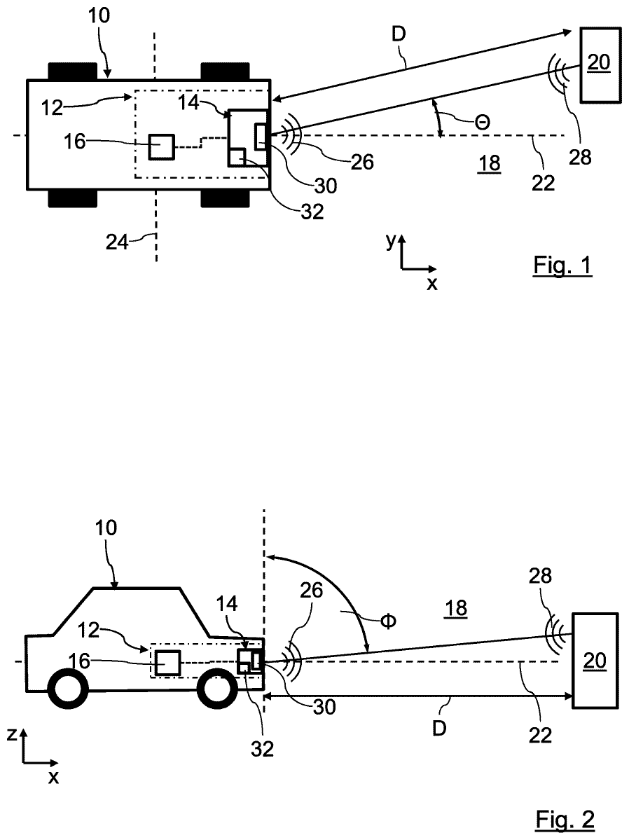

In FIG. 1, a vehicle 10 in the form of a passenger car is shown in plan view in a driving situation. FIG. 2 shows the vehicle 10 in a side view.

The vehicle 10 comprises a driver assistance system 12. By way of example, the driver assistance system 12 has a radar system 14 and a control device 16.

The radar system 14 is arranged by way of example on the front side of the vehicle 10. With the radar system 14, a monitoring area 18 in front of the vehicle 10 can be monitored for objects 20. In FIGS. 1 and 2, an object 20 that can be detected with the radar system 14 is arranged by way of example in front of the vehicle 10. The radar system 14 may also be arranged at a different location of the vehicle 10, and also be aligned differently. Multiple radar systems 14 may also be provided at different locations and with different alignments.

With the radar system 14, object information, for example distances D, directions, by way of example azimuth θ and elevation angles φ, and speeds of detected objects 20 relative to the vehicle 10, can be determined.

The radar system 14 is functionally connected to the control device 16 of the driver assistance system 14. Object information determined with the radar system 14 can thus be transmitted to the control device 16. With the driver assistance system 12, the vehicle 10 can be operated autonomously or partially autonomously.

For easier orientation, the corresponding coordinates of a Cartesian x-y-z coordinate system are indicated in FIGS. 1 to 4. By way of example, the x axis of the x-y-z coordinate system runs parallel to the vehicle longitudinal axis 22 of the vehicle 10. The y axis runs parallel to a vehicle transverse axis 24 of the vehicle 10 and the z axis runs spatially upward, perpendicularly to the x-y plane.

With the radar system 14, radar signals 26 can be sent into the monitoring area 18. Radar signals 26 reflected at objects 20 in the direction of the radar system 14 can be received by the radar system 14 as echo signals 28. The corresponding object information can be determined from the echo signals 28.

The radar system 14 comprises an antenna arrangement 30 and a control and evaluation device 32.

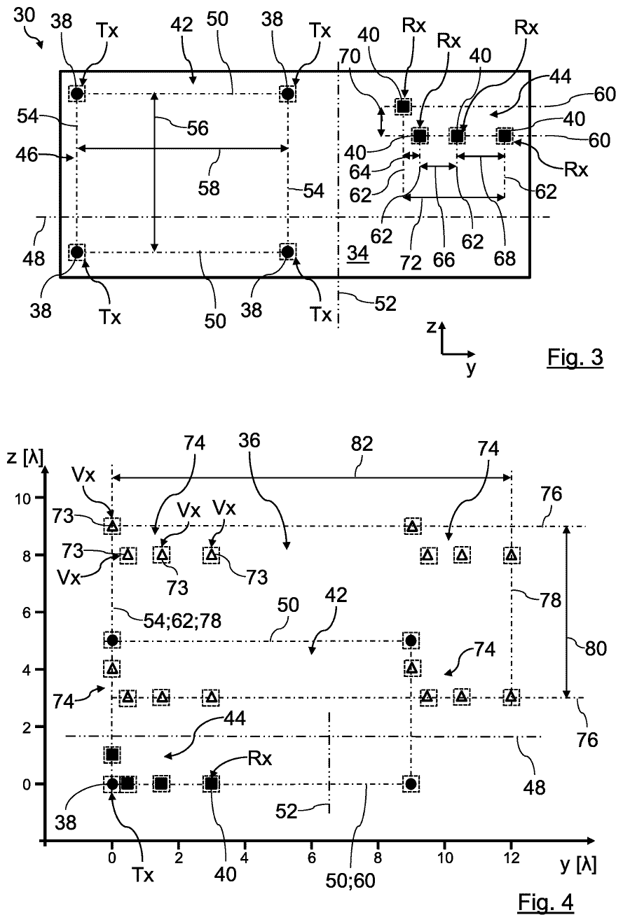

The antenna arrangement 30 is shown in FIG. 3 in a front view, as seen from the monitoring area 18. The antenna arrangement 30 comprises two antenna element types, to be specific transmitting antenna elements Tx and receiving antenna elements Rx. With the transmitting antenna elements Tx, radar signals 26 can be sent. With the receiving antenna elements Rx, echo signals 28 can be received.

The antenna arrangement 30 has four transmitting antenna elements Tx and four receiving antenna elements Rx. The transmitting antenna elements Tx and the receiving antenna elements Rx are arranged on a common carrier in the form of a carrier plate 34.

With the control and evaluation device 32, the transmitting antenna elements Tx can be activated to emit radar signals 26. Furthermore, with the control and evaluation device 32, the echo signals 28 received with the receiving antenna elements Rx and converted into electrical receive signals can be detected and evaluated. With the control and evaluation device 32, the corresponding object information can be determined from the electrical receive signals and transmitted to the control device 16.

The radar system 14 is operated according to a MIMO (multiple-in-multiple-out) method. In the MIMO method, the transmitting antenna elements Tx are activated by the control and evaluation device 32 separately with transmit control signals. By means of corresponding transmit control signals, the radar signals 26 which are sent with the individual transmitting antenna elements Tx are made distinguishable, for example by coding. It is thus possible on the receiver side for signal paths of the radar signals 26 and the corresponding echo signals 28 to be assigned to the respective transmitting antenna elements Tx. Correspondingly, the receiving antenna elements Rx are selected separately. The electrical receive signals converted by the antenna elements Rx from the echo signals 28 are assigned correspondingly. Due to the separate activation or selection, all positions of the transmitting antenna elements Tx and all positions of the receiving antenna elements Rx can be used for realizing a virtual antenna array 36. Shown by way of example in FIG. 4 is the virtual antenna array 36, which can be realized with an alternative antenna arrangement 30, which is likewise shown in FIG. 4. The virtual antenna array 36 shown in FIG. 4 may also be realized with the antenna arrangement 30 from FIG. 3.

In FIGS. 3 and 4, the phase centers 38 of the transmitting antenna elements Tx are indicated as black-filled circles. The phase centers 40 of the receiving antenna elements Rx are indicated as black-filled squares.

In FIG. 3, a transmitting antenna element field 42 consisting of the four transmitting antenna elements Tx on the left side is shown separately from a receiving antenna element field 44 consisting of the four receiving antenna elements Rx on the right. The transmitting antenna element field 42 and the receiving antenna element field 44 may also be arranged in relation to one another in some other way. The transmitting antenna element field 42 and the receiving antenna element field 44 may also overlap, as shown at the bottom of FIG. 4.

The transmitting antenna elements Tx are arranged in a transmitting plane, at the corners of an imaginary planar rectangle 46. The rectangle 46 has different side lengths. The two longer sides of the rectangle 46 extend parallel to an imaginary first arrangement axis 48, which runs horizontally in FIG. 3, and form imaginary transmitting antenna element main axes 50. The other two, shorter sides of the rectangle 46 extend parallel to an imaginary second arrangement axis 52, which runs vertically in FIG. 3, and form imaginary transmitting antenna element transverse axes 54. The second arrangement axis 52 runs perpendicularly to the first arrangement axis 48. The transmitting antenna elements Tx thus form the rectangular transmitting antenna element field 42.

The phase centers 38 of the transmitting antenna elements Tx are arranged at the intersections of the transmitting antenna element main axes 50 with the corresponding transmitting antenna element transverse axes 54.

A respective distance between the adjacent transmitting antenna element main axes 50 or between the adjacent transmitting antenna element transverse axes 54, that is to say between the respectively adjacent antenna element axes for the same antenna element type, is an integer multiple of a predetermined base distance V2. The base distance λ/2 corresponds to half the wavelength λ/2 of radar signals 26 sent by the radar system 14.

In the exemplary embodiment shown in FIG. 3, the distance 56 between the transmitting antenna element main axes 50 corresponds to ten times the base distance λ/2, that is to say 5λ. The distance between the transmitting antenna element transverse axes 54 corresponds to 18 times the base distance λ/2, that is to say 91.

The phase centers 40 of the four receiving antenna elements Rx are arranged in a manner distributed over two imaginary receiving antenna element main axes 60 and four imaginary receiving antenna element transverse axes 62. In this case, the phase centers 40 are respectively arranged at an intersection of a receiving antenna element main axis 60 with a receiving antenna element transverse axis 62.

The receiving antenna element main axes 60 extend parallel to and at a distance from one another and parallel to the first arrangement axis 48. The four receiving antenna element transverse axes 62 extend parallel to and at a distance from one another, perpendicularly to the receiving antenna element main axes 60 and parallel to the second arrangement axis 52.

The receiving antenna element main axes 60 and the receiving antenna element transverse axes 62 extend in an imaginary receiving plane. The receiving antenna element main axes 60 and the receiving antenna element transverse axes 62, that is to say the receiving plane, also extend parallel to a plane spanned by the transmitting antenna element main axes 50 and the transmitting antenna element transverse axes 54. The receiving plane with the receiving antenna element main axes 60 and the receiving antenna element transverse axes 62 extends parallel to the transmitting plane with the transmitting antenna element main axes 50 and the transmitting antenna element transverse axes 54.

The phase center 40 of one of the receiving antenna elements Rx is arranged on one of the receiving antenna element main axes 60, in FIG. 3 the upper receiving antenna element main axis 60. The phase centers 40 of the other three receiving antenna elements Rx are each arranged on the other, lower receiving antenna element main axis 60. The phase centers 40 of the four receiving antenna elements Rx are arranged on different receiving antenna element transverse axes 62.

The receiving antenna element transverse axis 62 on which there is the phase center 40 of the receiving antenna element Rx which is arranged on its own on the upper receiving antenna element main axis 60 lies at the left edge of the receiving antenna element field 44, that is to say not between two others of the receiving antenna element transverse axes 62.

A respective distance between the adjacent receiving antenna element main axes 60 or between the adjacent receiving antenna element transverse axes 62, that is to say between the respectively adjacent antenna element axes for the same antenna element type, is an integer multiple of the base distance λ/2. All distances between the respectively adjacent receiving antenna element transverse axes 62 are different.

A distance 64 of the receiving antenna element transverse axis 62 on which there is the phase center 40 of the individual receiving antenna element Rx which is arranged on its own on the corresponding receiving antenna element main axis 60, at the left edge of the receiving antenna element field 44 in FIG. 3, from the adjacent, the second receiving antenna element transverse axis 62 from the left, is smaller than the other distances 66 and 68 between respectively adjacent other receiving antenna element transverse axes 62.

In the exemplary embodiment shown in FIG. 3, the distance 70 between the receiving antenna element main axes 60 corresponds to twice the base distance λ/2, i.e. λ. The distance 64 between the receiving antenna element transverse axis 62 with the individual receiving antenna element Rx at the left edge of the receiving antenna field and the adjacent, second receiving antenna element transverse axis 62 corresponds to once the base distance λ/2, i.e. λ/2. The distance 66 between the second receiving antenna element transverse axis 62 and the third receiving antenna element transverse axis 62 from the left corresponds to twice the base distance λ/2, i.e. λ. The distance 68 between the third receiving antenna element transverse axis 62 from the left and the fourth receiving antenna element transverse axis 62 from the left, that is to say the receiving antenna element transverse axis 62 at the right edge of the receiving antenna field 44 in FIG. 3, corresponds to three times the base distance λ/2, i.e. 1.5 λ.

The longer sides of the rectangle 46 of the transmitting antenna elements Tx, that is to say the longer sides of the transmitting antenna element field 42, run parallel to the arrangement axis to which the receiving antenna element axes in the direction of which the receiving antenna element field 40 has the greatest extent also run. In the exemplary embodiment shown, the transmitting antenna element main axes 50 and the receiving antenna element main axes 60 run parallel to one another and parallel to the first arrangement axis 48.

An extent of the transmitting antenna element field 42 in the direction of the first arrangement axis 48 is greater than an extent 72 of the receiving antenna element field 44 in the direction of the first arrangement axis 48. In the exemplary embodiment shown in FIG. 3, the extent of the transmitting antenna element field 42 in the direction of the first arrangement axis 48 corresponds to the distance 58 between the transmitting antenna element transverse axes, that is to say 18 times the base distance λ/2, i.e. 9λ. The extent 72 of the receiving antenna element field 44 in the direction of the first arrangement axis 48 corresponds to the sum of the distances 64, 66 and 68 between the receiving antenna element transverse axes 62, that is to say six times the base distance λ/2, i.e. 3λ.

An extent of the transmitting antenna element field 42 in the direction of the second arrangement axis 52 is greater than an extent of the receiving antenna element field 44 in the direction of the second arrangement axis 52. In the exemplary embodiment shown, the extent of the transmitting antenna element field 42 in the direction of the second arrangement axis 52 corresponds to the distance 56 between the transmitting antenna element main axes 50, that is to say ten times the base distance λ/2, i.e. 5λ. The extent of the receiving antenna field 44 in the direction of the second arrangement axis 52 corresponds to the distance 70 between the receiving antenna element main axes 60, that is to say twice the base distance λ/2, i.e. λ.

In FIG. 4, the alternative to the antenna arrangement 30 from FIG. 3 is shown, and the virtual antenna array 36 that can be realized therewith. For easier orientation, coordinate axes with the y coordinates and the z coordinates are also shown. The y coordinates and the z coordinates are respectively indicated in the wavelength λ. The origin of the coordinate system (0,0) was placed in the phase center 38 of the lower left transmitting antenna element Tx for the sake of easier orientation.

The alternative antenna arrangement 30 shown in FIG. 4 comprises the transmitting antenna element field 42 and the receiving antenna element field 44 from FIG. 3, though FIGS. 3 and 4 are not to scale. In contrast to the antenna arrangement 30 from FIG. 3, in the alternative antenna arrangement 30 the receiving antenna element field 44 is placed within the transmitting antenna element field 42. In this case, the lower transmitting antenna element main axis 50 and the lower receiving antenna element main axis 60 coincide. Furthermore, the left transmitting antenna element transverse axis 54 and the left receiving antenna element transverse axis 62 coincide. In FIG. 4, only one of the transmitting antenna elements Tx with its phase center 38 and one of the receiving antenna elements Rx with its phase center 40 are respectively provided with a reference numeral by way of example for the sake of better clarity.

The receiving antenna element field 44 is arranged such that the left lower transmitting antenna element Tx is located at the intersection of the lower receiving antenna element main axis 60 with the left receiving antenna element transverse axis 62. The left lower transmitting antenna element Tx is located, as it were, in the gap of the receiving antenna element field 44 that results due to the upward offset of the left receiving antenna element Rx with respect to the upper receiving antenna element main axis 60. Overall, the alternative antenna arrangement 30 from FIG. 4 is of a more space-saving construction than the antenna arrangement 30 from FIG. 3.

Both with the antenna arrangement 30 from FIG. 3 and with the antenna arrangement 30 from FIG. 4, the virtual antenna array 36 shown in FIG. 4 can be realized.

For the alternative antenna arrangement 30 from FIG. 4, and correspondingly with the antenna arrangement 30 from FIG. 3, the antenna array 36 with altogether 16 virtual antenna elements Vx is generated during operation of the radar system 14. The virtual antenna array 36 is realized by geometric folding of the geometric positions of the phase centers 38 of the transmitting antenna elements Tx and the phase centers 40 of the receiving antenna elements Rx of the antenna arrangement 30 or the alternative antenna arrangement 30. The virtual antenna elements Vx act as virtual receiving antenna elements for the echo signals 28.

In FIG. 4, the virtual antenna elements Vx of the virtual antenna array 36 are shown. The virtual phase centers 73 of the virtual antenna elements Vx of the virtual antenna array 70 are indicated as white-filled triangles. For the sake of better clarity, in FIG. 4 only four of the virtual antenna elements Vx are labeled by way of example.

The virtual antenna array 36 comprises four virtual antenna element fields 74. The virtual antenna element fields 74 are identically constructed, of the same size and have the same orientation. Each of the virtual antenna element fields 74 comprises four virtual antenna elements Vx. The four virtual antenna elements Vx of each virtual antenna element field 74 are arranged in a way corresponding to the four receiving antenna elements Rx of the antenna arrangement 30.

The virtual antenna element fields 74 are respectively arranged at the corners of an imaginary rectangle. The long sides of the rectangle run parallel to the first arrangement axis 48 and form respective virtual main axes 76. The short sides of the rectangle run parallel to the second arrangement axis 52 and form respective virtual transverse axes 78.

In the exemplary embodiment shown in FIG. 4, the left virtual transverse axis 78 coincides with the left transmitting antenna element transverse axis 54 and the left receiving antenna element transverse axis 62. The lower virtual main axis 76 runs between the upper transmitting antenna element main axis 50 and the lower transmitting antenna element main axis 50 and above the upper receiving antenna element main axis 60. The upper virtual main axis 76 runs above the upper transmitting antenna element main axis 50. The right virtual transverse axis 78 runs to the right of the right transmitting antenna element transverse axis 54.

The virtual phase center 73 of the left virtual antenna element Vx of the virtual antenna element field 74 at the top left lies at the intersection of the upper virtual main axis 76 and the left virtual transverse axis 78.

The free space below the left virtual antenna element Vx of the virtual antenna element field 74 at the bottom left lies at the intersection of the lower virtual main axis 76 and the left virtual transverse axis 78.

The free space above the right virtual antenna element Vx of the virtual antenna element field 74 at the top right lies at the intersection of the upper virtual main axis 76 and the right virtual transverse axis 78.

The virtual phase center 73 of the right virtual antenna element Vx of the virtual antenna element field 74 at the bottom right lies at the intersection of the lower virtual main axis 76 and the right virtual transverse axis 78.

Overall, the virtual phase centers 73 of the uppermost virtual antenna elements Vx of the virtual antenna array 36 thus lie on the upper virtual main axis 76. The phase centers 73 of the lowermost virtual antenna elements Vx lie on the lower virtual main axis 76. A distance 80 between the upper virtual main axis 76 and the lower virtual main axis 76 thus indicates the aperture of the virtual antenna array 36 in this direction, by way of example in the vertical direction. The distance 80, and thus the vertical aperture by way of example, corresponds to twelve times the base distance λ/2, i.e. 6λ. The distance 80 corresponds to the sum of the extent of the transmitting antenna field 42 in the vertical direction, to be specific the distance 56, and the vertical extent 70 of the receiving antenna element field 44.

The virtual phase centers 73 of the leftmost virtual antenna elements Vx of the virtual antenna array 36 lie on the left virtual transverse axis 78. The phase centers 73 of the rightmost virtual antenna elements Vx lie on the right virtual transverse axis 78. A distance 82 between the left virtual transverse axis 78 and the right virtual transverse axis 78 accordingly indicates the aperture of the virtual antenna array 36 in this direction, by way of example in the horizontal direction. The distance 82, and thus the horizontal aperture by way of example, corresponds to 24 times the base distance, i.e. 12λ. The distance 82 corresponds to the sum of the horizontal extent of the transmitting antenna field 42, to be specific the distance 58, and the horizontal extent of the receiving antenna element field 44, to be specific the distance 72.

1. An antenna arrangement for a radar system for a vehicle, comprising:
four type-1 antenna elements of a first antenna element type and at least two type-2 antenna elements of a second antenna element type, one of the antenna element types being transmitting antenna elements and the other of the antenna element types being receiving antenna elements,
wherein the type-1 antenna elements are arranged in a plane at corners of an imaginary planar rectangle, wherein two sides imaginary planar rectangle extend parallel to an imaginary first arrangement axis and form type-1 antenna element main axes and the other two sides of the imaginary planar rectangle extend parallel to an imaginary second arrangement axis that runs perpendicularly to the first arrangement axis and form type-1 antenna element transverse axes, and
wherein at least two of the type-2 antenna elements are arranged on different imaginary type-2 antenna element main axes, which extend parallel to and at a distance from one another and parallel to one of the first and second arrangement axes.

2. The antenna arrangement as claimed in claim 1, wherein at least two of the type-2 antenna elements are arranged on different imaginary type-2 antenna element transverse axes, which extend parallel to and at a distance from one another and perpendicularly to the type-2 antenna element main axes.

3. The antenna arrangement as claimed in claim 2,
wherein the antenna arrangement has at least three type-2 antenna element transverse axes at a distance from one another and at least three type-2 antenna elements, wherein all distances between the respectively adjacent type-2 antenna element transverse axes are different and at least three of the type-2 antenna elements are arranged on different type-2 antenna element transverse axes, and/or
the antenna arrangement has at least three type-2 antenna elements, one of the type-2 antenna elements of which is arranged on one of the type-2 antenna element main axes and all the other of the type-2 antenna elements of which are arranged on the type-2 antenna element transverse axis containing the type-2 antenna element which is arranged on its own on the type-2 antenna element main axis does not lie between two other type-2 antenna element transverse axes, and/or
the antenna arrangement has at least four type-2 antenna elements, one type-2 antenna element of which is arranged on one of the type-2 antenna element main axes and all the other type-2 antenna elements of which are arranged on the other type-2 antenna element main axis, and a distance of a type-2 antenna element transverse axis on which there is the type-2 antenna element which is arranged on its own on the corresponding type-2antenna element main axis from at least one adjacent type-2 antenna element transverse axis is smaller than the other distances between respectively adjacent type-2 antenna element transverse axes, and/or
the antenna arrangement has four type-2 antenna elements.

4. The antenna arrangement as claimed in claim 2,
wherein the type-2 antenna element main axes and the type-2 antenna element transverse axes, extend in a common imaginary plane, and/or
the type-2 antenna element main axes and the type-2 antenna element transverse axes extend parallel to a plane spanned by the type-1 antenna element main axes and the type-1 antenna element transverse axes, and/or
the type-1 antenna elements and the type-2 antenna elements are arranged on a common carrier plate.

5. The antenna arrangement as claimed in claim 2, wherein phase centers of all the antenna elements, are arranged on the antenna element main axes and/or the antenna element transverse axes.

6. The antenna arrangement as claimed in claim 2, wherein a respective distance between adjacent antenna element main axes and/or a respective distance between adjacent antenna element transverse axes for the same antenna element type, is an integer multiple of a predetermined base distance, the base distance corresponding to half the wavelength of radar signals sent by the radar system.

7. The antenna arrangement as claimed in claim 2,
wherein an extent of a transmitting antenna element field which consists of the antenna elements of the transmitting-antenna element type in a direction of the first arrangement axis is greater than an extent of a receiving antenna element field which consists of the antenna elements of the receiving-antenna element type in the direction of the first arrangement axis, and an extent of the transmitting antenna element field in a direction of the second arrangement axis is greater than an extent of the receiving antenna element field in the direction of the second arrangement axis, and/or
the imaginary planar rectangle for the type-1 antenna elements has different side lengths, longer sides running parallel to the arrangement axis in relation to which the type-2 antenna element main axes or type-2 antenna element transverse axes in a direction of which a type-2 antenna element field which consists of the type-2 antenna elements has the greatest extent also run.

8. The antenna arrangement as claimed in claim 1,
wherein the antenna arrangement is designed for the use of the radar system according to a multiple-in/multiple-out (MIMO) method, and/or
the type-1 antenna elements are respectively activated, and/or
selected separately and the type-2 antenna elements are respectively activated and/or selected separately.

9. A radar system comprising at least one antenna arrangement which has four type-1 antenna elements of a first antenna element type and at least two type-2 antenna elements of a second antenna element type, one of the antenna element types being transmitting antenna elements and the other of the antenna element types being receiving antenna elements, wherein the radar system has at least one antenna arrangement as claimed in claim 1.

10. A driver assistance system comprising:
at least one radar system; and
at least one antenna arrangement for the at least one radar system, the at least one antenna arrangement having four type-1 antenna elements of a first antenna element type and at least two type-2 antenna elements of a second antenna element type, one of the antenna element types being transmitting antenna elements and the other of the antenna element types being receiving antenna elements,
wherein the driver assistance system has at least one antenna arrangement as claimed in one of claim 1.

11. A vehicle comprising:
at least one radar system; and
at least one antenna arrangement for the at least one radar system, the at least one antenna arrangement having four type-1 antenna elements of a first antenna element type and at least two type-2 antenna elements of a second antenna element type, one of the antenna element types being transmitting antenna elements and the other of the antenna element types being receiving antenna elements,
wherein the vehicle has at least one antenna arrangement as claimed in one of claim 1.

12. A method for operating a radar system for a vehicle with at least one antenna arrangement which has four type-1 antenna elements of a first antenna element type and at least two type-2 antenna elements of a second antenna element type, comprising:
sending radar signals with the antenna elements of one of the antenna element types; and
receiving echo signals which originate from the radar signals with the antenna elements of the other antenna element type, wherein the radar signals are sent and the echo signals are received with an antenna arrangement as claimed in claim 1.
